(19) United States
(12) Patent Application Publication
(10) Pub. No.: US 2015/0100641 A1
(43) Pub. Date: Apr. 9, 2015

(54) Communications Method, Apparatus and System for Mobile Devices

(71) Applicant: Tencent Technology (Shenzhen) Company Limited, Shenzhen (CN)

(72) Inventors: Yaode HUANG, Shenzhen (CN); Lin CHEN, Shenzhen (CN); Peng JIANG, Shenzhen (CN)

(21) Appl. No.: 14/569,078

(22) Filed: Dec. 12, 2014

Related U.S. Application Data
(63) Continuation of application No. PCT/CN2013/076869, filed on Jun. 6, 2013.

(30) Foreign Application Priority Data
Jun. 20, 2012 (CN) 201210205224.7

(51) Int. Cl. H04L 12/18; H04L 29/08

(52) U.S. Cl. CPC H04L 12/1822; H04L 67/22
USPC 709/204

(57) ABSTRACT

The invention discloses a communication method, apparatus and system for mobile devices, which pertains to the field of communication. The method comprises: obtaining additional instruction information that corresponds to a first user operation during communication by sensing the first user operation; the first user operation comprises at least one of a voice-activated operation or a one-step operation on a first mobile device; and transmitting the additional instruction information to a second mobile device, so that the second mobile device recognizes the additional instruction information to further notify a second user of the second mobile device of the first user operation. The apparatus comprises an acquisition module and a transmitting module. The system includes a first mobile device and a second mobile device.

### CROSS REFERENCE TO RELATED APPLICATIONS

This application is a U.S. continuation application under 35 U.S.C. §111(a) claiming priority under 35 U.S.C. §§120 and 365(c) to International Application No. PCT/CN2013/076869, filed Jun. 6, 2013 which claims the priority benefit of Chinese Patent Application No. 2012102052247, filed on Jun. 20, 2012, and entitled “Communication method, apparatus and communication system for mobile devices”, the contents of which are incorporated by reference herein in their entirety for all purposes.

### FIELD OF THE INVENTION

The invention relates to the field of communication technology, and particularly, to a communication method, apparatus and system for mobile devices.

### BACKGROUND

As the development of communication technology, mobile devices such as mobile phones and tablets etc. have more and more functions. A user not only can dial telephone numbers, make voice calls and send text messages with a mobile device; but also can make text, image, emoticon communication through chat tools within the mobile device. Currently, when communicating through a mobile device, if text communication is needed to be realized, then an input method may be opened firstly to input characters such as Pinyin so as to obtain words to which the Pinyin corresponds, from where the needed word input is then selected; and if emoticon communication is needed to be realized, then a pre-saved emoticon set may be opened, from where corresponding emoticons are selected for input.

However, in procedure of realizing the present invention, the inventor found that: when making a call through a mobile device, if text communication is needed to be realized, then a user has to make plurality of steps (e.g., opening, selecting, inputting, etc), calling operation of a mobile device is complex, and communication efficiency of a mobile device is low.

### SUMMARY OF THE INVENTION

An embodiment of the present invention provides a communication method, apparatus and system for mobile devices; the technical solutions are as follows:

A communication method for mobile devices, comprising:

obtaining additional instruction information that corresponds to a first user operation during communication by sensing the first user operation; the first user operation comprises at least one of a voice-activated operation or a one-step operation on a first mobile device;

transmitting the additional instruction information to a second mobile device, so that the second mobile device recognizes the additional instruction information to further notify a second user of the second mobile device of the first user operation.

A communication apparatus for mobile devices, comprising:

an acquisition module for obtaining additional instruction information that corresponds to a first user operation during communication by sensing the first user operation; the first user operation comprises at least one of a voice-activated operation or a one-step operation on a first mobile device; and

a transmitting module for transmitting the additional instruction information to a second mobile device so that the second mobile device recognizes the additional instruction information to further notify a second user of the second mobile device of the first user operation, after the acquisition module obtains the additional instruction information that corresponds to a first user operation.

A communication system for mobile devices; the system comprises a first mobile device and a second mobile device.

The first mobile device comprises:

an acquisition module for obtaining additional instruction information that corresponds to a first user operation during communication by sensing the first user operation; the first user operation comprises at least one of a voice-activated operation or a one-step operation on a first mobile device;

a transmitting module for transmitting the additional instruction information to a second mobile device after the acquisition module obtains the additional instruction information that corresponds to a first user operation.

The second mobile device comprises:

a processing module for receiving the additional instruction information transmitted by the transmitting module, and recognizing the additional instruction information to further notify a second user of the second mobile device of the first user operation.

The technical solution provided by the embodiments of the invention at least has the following benefits:

It may obtain additional instruction information that corresponds to a first user operation during communication by sensing the first user operation; transmit the additional instruction information to a second mobile device, such that only a voice-activated operation or a one-step operation is needed to be perform on the mobile device to obtain the additional instruction information; it does not need a user to open selections for input, it operations are simple and convenient and may improve communication efficiency of mobile devices.

### DESCRIPTION OF THE DRAWINGS

In order to describe the technical solutions of the invention apparently, the invention will be further illustrated in brief in connection with accompanying figures hereinafter. It should be appreciated that the figures described herein are only some embodiments of the invention, and a person skilled in the art may obtain other figures based on theses ones without any creative effort being paid.

FIG. 1 is a flow diagram of a communication method for mobile devices provided by embodiment 1 of the present application;

FIG. 2 is a flow diagram of a communication method for mobile devices provided by embodiment 2 of the present application;

FIG. 3 is a structure schematic diagram of a communication apparatus for mobile devices provided by embodiment 3 of the present application; and

FIG. 4 is a structure schematic diagram of a communication system for mobile devices provided by embodiment 4 of the present application.

### DETAILED DESCRIPTION

In order to make the objects, technical solutions and advantages of the invention more apparent, the invention will be further illustrated in details in connection with accompanying figures and embodiments hereinafter.

### Embodiment 1

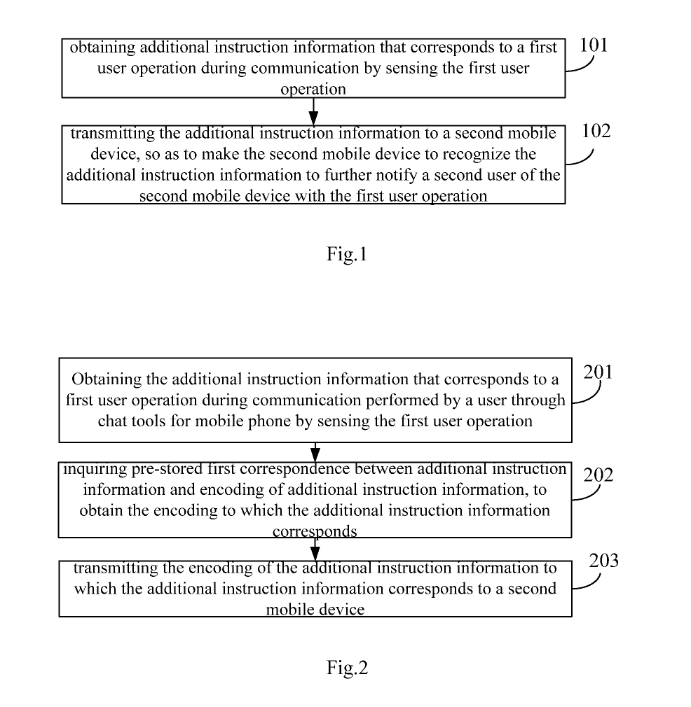

See FIG. 1, embodiment of the present invention provides a communication method for mobile devices.

At step S101, additional instruction information that corresponds to a first user operation is obtained during communication by sensing the first user operation; the first user operation comprises at least one of a voice-activated operation or a one-step operation on a first mobile device.

At step S102, the additional instruction information is transmitted to a second mobile device, so that the second mobile device recognizes the additional instruction information to further notify a second user of the second mobile device of the first user operation.

Further, transmitting the additional instruction information to the second mobile device comprises:

inquiring pre-stored first correspondence between additional instruction information and encoding information of additional instruction information, to obtain the encoding information to which the additional instruction information corresponds;

transmitting the encoding information of the additional instruction information to the second mobile device.

Accordingly, recognizing, by the second mobile device, the additional instruction information to further notify a second user of the second mobile device of the first user operation comprises:

receiving, by the second mobile device, the encoding information of the additional instruction information

inquiring, by the second mobile device, pre-stored second correspondence between additional instruction information and encoding information of additional instruction information, to obtain the encoding information to which the additional instruction information corresponds;

recognizing, by the second mobile device, the additional instruction information to further notify a second user of the second mobile device of the first user operation.

Further, the one-step operation on the first mobile device comprises:

a one-step operation on a screen of the first mobile device, or

a one-step operation on the first mobile device itself

The communication method for mobile devices described in embodiments of the invention may obtain additional instruction information that corresponds to a first user operation during communication by sensing the first user operation; transmit the additional instruction information to a second mobile device, such that only a voice-activated operation or a one-step operation is needed to be perform on the mobile device to obtain the additional instruction information; it does not need a user to open selections for input, it operations are simple and convenient and may improve communication efficiency of mobile devices. By inquiring pre-stored first correspondence between additional instruction information and encoding information of additional instruction information, the additional instruction information is transmitted to the second mobile device in manner of its encoding, its implementation is simple and convenient and may further improve communication efficiency of mobile devices.

The communication method for mobile devices described in embodiments of the invention may be applied to various mobile devices such as mobile phones. Next it would be further described by taking a chat tool applied to a mobile phone as an example.

### Embodiment 2

See FIG. 2, embodiment of the present invention provides a communication method for mobile devices.

At step S201, additional instruction information that corresponds to a first user operation is obtained during communication performed by a user through chat tools for mobile phone by sensing the first user operation; the first user operation comprises at least one of a voice-activated operation or a one-step operation on a first mobile device.

Wherein the one-step operation on the first mobile device comprises a one-step operation on a screen of the mobile phone or a one-step operation on the mobile phone itself; such as knocking on screen of a mobile phone, kissing on screen of a mobile phone, shaking a mobile phone itself and etc. For additional instruction information that corresponds to the first user operation, specifically, additional instruction information (including text, emoticon, or image, etc) to which each kind of user operation corresponds may be pre-set; for example, an operation of knocking on screen of a mobile phone may be set to correspond to a ringtone of knocking (or doorbell), an operation of kissing on screen of a mobile phone may be set to correspond to a an emoticon of kissing, an operation of shaking a mobile phone itself may be set to correspond to a an effect of vibration, and so on. A correspondence is established between user operations and additional instruction information, further, the correspondence between user operations and additional instruction information may be specifically stored in manner of form or data set, which would not be further defined herein.

It should be noted that in procedure of realizing the present invention, when making a call through a mobile device, if text, image or emoticon communication is needed to be realized, then a user has to make plurality of steps. In contrary, a user only needs knock on screen of a mobile phone, kiss on screen of a mobile phone, or shake a mobile phone itself to realize text, image or emoticon communication. For the convenience of distinguishing operations to mobile devices in the invention from those in the prior art, an operation on a mobile device in the prior art (such as opening, selecting and inputting) are referred to as a multi-steps operation, and an operation on a mobile device in the invention are referred to as a one-step operation.

Additional instruction information that corresponds to a first user operation is obtained by sensing the first user operation, specifically; it may be implemented by technology of Multi-Touch, gravity sensing, light sensing, airflow sensing and other technologies. For example, an operation of knocking on screen of a mobile phone may be sensed by technology of Multi-Touch, an operation of kissing on screen of a mobile phone may be sensed by technology of airflow sensing, an operation of shaking a mobile phone itself may be sensed by technology of gravity sensing.

At step S202, pre-stored first correspondence between additional instruction information and encoding information of additional instruction information is inquired, to obtain the encoding information to which the additional instruction information corresponds.

Specifically, encoding information of additional instruction information to which each kind of additional instruction information corresponds may be pre-set; for example, encoding of a ringtone of knocking (or doorbell) may be set as 1001, encoding of an emoticon of kissing may be set as 1002, and so on. Further, the correspondence between encoding information of additional instruction information and additional instruction information may be specifically stored in manner of form or data set, which would not be further defined herein.

It should be illustrated that when the additional instruction information obtained by a method of the invention is an emoticon, then in order to distinguish it from emoticons in the existing chat tools (may be referred to as “normal emoticons”), encodings of emoticons obtained by a method of the invention (may be referred to as “special emoticons”) are set to be different with encodings of emoticons in the existing chat tools. Specifically, a new set of special emoticons fields may be defined, for example, emoticons in the existing chat tools starts with bytes of 0×14, then special emoticons may define new start bytes; establish a set of special correspondence between special emoticons and encodings to define a marker start byte (usually an invisible byte to avoid a user from inputting an identical byte).

It should be also illustrated that the first correspondence between encoding information of additional instruction information and additional instruction information may be stored in the first mobile device directly, or it may be stored in a server, no definition would be made herein. According to different storage locations of correspondence between encoding information of additional instruction information and additional instruction information, optionally, inquiring pre-stored first correspondence between additional instruction information and encoding information of additional instruction information, to obtain the encoding information to which the additional instruction information corresponds, comprising: locally inquiring pre-stored first correspondence between additional instruction information and encoding information of additional instruction information, to obtain the encoding information to which the additional instruction information corresponds, or inquiring a first server for pre-stored first correspondence between additional instruction information and encoding information of additional instruction information, to obtain the encoding information to which the additional instruction information corresponds.

At step S203, the encoding information of the additional instruction information to which the additional instruction information corresponds is transmitted to a second mobile device.

Specifically, the encoding is not limited to be transmitted to one mobile device, it may also be transmitted to a plurality of mobile devices.

It should be illustrated that after transmitting the encoding information of the additional instruction information to which the additional instruction information corresponds to the second mobile device, the method further comprises:

receiving, by the second mobile device, the encoding information of the additional instruction information

inquiring, by the second mobile device, pre-stored second correspondence between additional instruction information and encoding information of additional instruction information, to obtain the encoding information to which the additional instruction information corresponds;

recognizing, by the second mobile device, the additional instruction information to further notify a second user of the second mobile device of the first user operation.

It should be illustrated that the second correspondence between encoding information of additional instruction information and additional instruction information may be stored in the first mobile device directly, or it may be stored in a server. If the first correspondence between encoding information of additional instruction information and additional instruction information, and the second correspondence between encoding information of additional instruction information and additional instruction information are both stored in a same server, then the second correspondence between encoding information of additional instruction information and additional instruction information may not be set and the first correspondence between encoding information of additional instruction information and additional instruction information may be employed directly. Thus optionally, inquiring, by the second mobile device, pre-stored second correspondence between additional instruction information and encoding information of additional instruction information, to obtain the encoding information to which the additional instruction information corresponds comprises: inquiring the second server, by the second mobile device, for pre-stored second correspondence between additional instruction information and encoding information of additional instruction information to obtain the encoding information to which the additional instruction information corresponds, or locally inquiring, by the second mobile device, pre-stored second correspondence between additional instruction information and encoding information of additional instruction information, to obtain the encoding information to which the additional instruction information corresponds. Wherein the first server and the second server may be one same server or be different servers, which would not be specifically defined in this embodiment.

It should be also illustrated that transmitting the encoding information of additional instruction information, to obtain the encoding information to which the additional instruction information corresponds to the second mobile device may specifically be:

transmitting the encoding information to which the additional instruction information corresponds to the server, and then the transmitting, by the server, the encoding information of additional instruction information to the second mobile device.

Further, upon the encoding information to which the additional instruction information corresponds is transmitted to the server, the server may convert the encoding information of additional instruction information into server unified coding sequence number for additional instruction information, then the server transmits the server unified coding sequence number for additional instruction information to the second mobile device. Accordingly, upon receiving the server unified coding sequence number for additional instruction information, the second mobile device needs to inquire pre-stored additional instruction information and unified coding sequence number for additional instruction information to obtain the additional instruction information.

The communication method for mobile devices described in embodiments of the invention may obtain additional instruction information that corresponds to a first user operation during communication by sensing the first user operation; transmit the additional instruction information to a second mobile device, such that only a voice-activated operation or a one-step operation is needed to be perform on the mobile device to obtain the additional instruction information; it does not need a user to open selections for input, it operations are simple and convenient and may improve communication efficiency of mobile devices. By inquiring pre-stored first correspondence between additional instruction information and encoding information of additional instruction information, the additional instruction information is transmitted to the second mobile device in manner of its encoding, its implementation is simple and convenient and may further improve communication efficiency of mobile devices.

### Embodiment 3

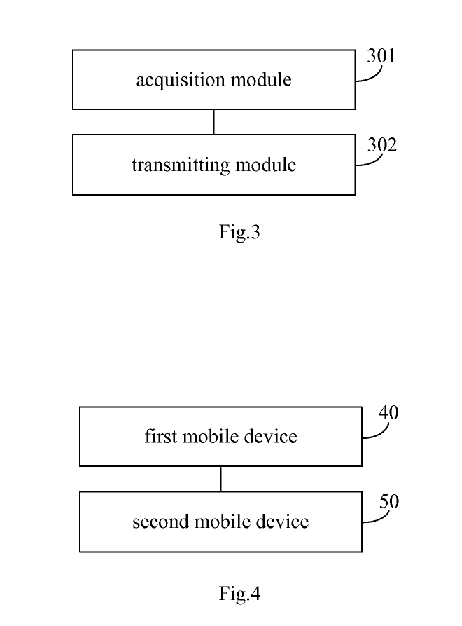

See FIG. 3, embodiment of the present invention provides a communication apparatus for mobile devices, the apparatus comprises:

an acquisition module 301 for obtaining additional instruction information that corresponds to a first user operation during communication by sensing the first user operation; the first user operation comprises at least one of a voice-activated operation or a one-step operation on a first mobile device;

a transmitting module 302, for transmitting the additional instruction information to a second mobile device so that the second mobile device recognizes the additional instruction information to further notify a second user of the second mobile device of the first user operation, after the acquisition module 301 obtains the additional instruction information that corresponds to a first user operation.

Further, the transmitting module 302 comprises:

a first querying unit for inquiring pre-stored first correspondence between additional instruction information and encoding information of additional instruction information, to obtain the encoding information to which the additional instruction information corresponds;

a transmitting unit for transmitting the encoding information of the additional instruction information to the second mobile device, so as to make a second mobile device to: receive the encoding information of the additional instruction information, inquire pre-stored second correspondence between additional instruction information and encoding information of additional instruction information, to obtain the encoding information to which the additional instruction information corresponds; and recognize the additional instruction information to further notify a second user of the second mobile device of the first user operation.

Further, the one-step operation on the first mobile device comprises:

a one-step operation on a screen of the first mobile device, or

a one-step operation on the first mobile device itself

The communication apparatus for mobile devices described in embodiments of the invention may obtain additional instruction information that corresponds to a first user operation during communication by sensing the first user operation; transmit the additional instruction information to a second mobile device, such that only a voice-activated operation or a one-step operation is needed to be perform on the mobile device to obtain the additional instruction information; it does not need a user to open selections for input, it operations are simple and convenient and may improve communication efficiency of mobile devices. By inquiring pre-stored first correspondence between additional instruction information and encoding information of additional instruction information, the additional instruction information is transmitted to the second mobile device in manner of its encoding, its implementation is simple and convenient and may further improve communication efficiency of mobile devices.

### Embodiment 4

See FIG. 4, embodiment of the present invention provides a communication system for mobile devices; the system comprises a first mobile device 40 and a second mobile device 50.

The first mobile device 40 comprises:

an acquisition module for obtaining additional instruction information that corresponds to a first user operation during communication by sensing the first user operation; the first user operation comprises at least one of a voice-activated operation or a one-step operation on a first mobile device;

a transmitting module for transmitting the additional instruction information to a second mobile device after the acquisition module obtains the additional instruction information that corresponds to a first user operation.

The second mobile device 50 comprises:

a processing module for receiving the additional instruction information transmitted by the transmitting module, and recognizing the additional instruction information to further notify a second user of the second mobile device of the first user operation.

Further, the transmitting module 302 comprises:

a first querying unit for inquiring pre-stored first correspondence between additional instruction information and encoding information of additional instruction information, to obtain the encoding information to which the additional instruction information corresponds;

a transmitting unit for transmitting the encoding information of the additional instruction information to the second mobile device, after the first querying unit obtains the encoding information to which the additional instruction information corresponds.

Accordingly, the processing module comprises:

a receiving unit for receiving the additional instruction information transmitted by the transmitting module;

a second querying unit for inquiring pre-stored second correspondence between additional instruction information and encoding information of additional instruction information, to obtain the encoding information to which the additional instruction information corresponds;

a processing unit for recognizing the additional instruction information to further notify a second user of the second mobile device of the first user operation, after the second querying unit obtains the encoding information to which the additional instruction information corresponds.

The communication system for mobile devices described in embodiments of the invention may obtain additional instruction information that corresponds to a first user operation during communication by sensing the first user operation; transmit the additional instruction information to a second mobile device, such that only a voice-activated operation or a one-step operation is needed to be perform on the mobile device to obtain the additional instruction information; it does not need a user to open selections for input, it operations are simple and convenient and may improve communication efficiency of mobile devices. By inquiring pre-stored first correspondence between additional instruction information and encoding information of additional instruction information, the additional instruction information is transmitted to the second mobile device in manner of its encoding, its implementation is simple and convenient and may further improve communication efficiency of mobile devices.

Parts of all disclosure of the technical solution provided by the embodiments above may be implemented by software programming; the software program may be stored in readable storage medium such as hard drive, compact disc, floppy disk for computers.

The above described embodiments are merely preferred embodiments of the invention, but not intended to limit the invention. Any modifications, equivalent alternations and improvements that are made within the spirit and scope of the invention should be included in the protection scope of the invention.

What is claimed is:

1. A communication method for mobile devices, comprising:
obtaining additional instruction information that corresponds to a first user operation during communication by sensing the first user operation, the first user operation comprising at least one of a voice-activated operation or a one-step operation on a first mobile device;
transmitting the additional instruction information to a second mobile device, so that the second mobile device recognizes the additional instruction information to further notify a second user of the second mobile device of the first user operation.

2. The communication method for mobile devices according to claim 1, wherein transmitting the additional instruction information to the second mobile device comprises:
inquiring pre-stored first correspondence between additional instruction information and encoding information of additional instruction information, to obtain the encoding information to which the additional instruction information corresponds; and
transmitting the encoding information of the additional instruction information to the second mobile device.

3. The communication method for mobile devices according to claim 2, wherein inquiring the pre-stored first correspondence between additional instruction information and encoding information of additional instruction information comprising:
locally inquiring pre-stored first correspondence between additional instruction information and encoding information of additional instruction information, to obtain the encoding information to which the additional instruction information corresponds, or
inquiring a first server for pre-stored first correspondence between additional instruction information and encoding information of additional instruction information, to obtain the encoding information to which the additional instruction information corresponds.

4. The communication method for mobile devices according to claim 1, wherein after the additional instruction information is transmitted to the second mobile device, the communication method further comprises:
receiving, by the second mobile device, the encoding information of the additional instruction information;
inquiring, by the second mobile device, pre-stored second correspondence between the additional instruction information and the encoding information of additional instruction information, to obtain the encoding information to which the additional instruction information corresponds; and
recognizing, by the second mobile device, the additional instruction information to further notify a second user of the second mobile device of the first user operation.

5. The communication method for mobile devices according to claim 4, wherein inquiring, by the second mobile device, pre-stored second correspondence between additional instruction information and encoding information of additional instruction information, to obtain the encoding information to which the additional instruction information corresponds comprising:
locally inquiring, by the second mobile device, the pre-stored second correspondence between additional instruction information and encoding information of additional instruction information, to obtain the encoding information to which the additional instruction information corresponds, or
inquiring, by the second mobile device, a second server for the pre-stored second correspondence between additional instruction information and encoding information of additional instruction information, to obtain the encoding information to which the additional instruction information corresponds.

6. The communication method for mobile devices according to claim 1, wherein the one-step operation on the first mobile device comprises:
a one-step operation on a screen of the first mobile device, or
a one-step operation on the first mobile device itself

7. A communication apparatus for mobile devices, comprising:
an acquisition module for obtaining additional instruction information that corresponds to a first user operation during communication by sensing the first user operation; the first user operation comprising at least one of a voice-activated operation or a one-step operation on a first mobile device; and
a transmitting module for transmitting the additional instruction information to a second mobile device so that the second mobile device recognizes the additional instruction information to further notify a second user of the second mobile device of the first user operation, after the acquisition module obtains the additional instruction information that corresponds to the first user operation.

8. The communication apparatus for mobile devices according to claim 7, wherein the transmitting module comprises:
a first querying unit for inquiring pre-stored first correspondence between the additional instruction information and encoding information of additional instruction information, to obtain the encoding information to which the additional instruction information corresponds;
a transmitting unit for transmitting the encoding information of the additional instruction information to the second mobile device, so as to make a second mobile device to: receive the encoding information of the additional instruction information, inquire pre-stored second correspondence between additional instruction information and encoding information of additional instruction information, to obtain the encoding information to which the additional instruction information corresponds;
and recognize the additional instruction information to further notify a second user of the second mobile device of the first user operation.

9. The communication apparatus for mobile devices according to claim 8, wherein first querying unit is further for:
locally inquiring the pre-stored first correspondence between the additional instruction information and encoding information of the additional instruction information, to obtain the encoding information to which the additional instruction information corresponds, or
inquiring a first server for the pre-stored first correspondence between additional instruction information and encoding information of additional instruction information, to obtain the encoding information to which the additional instruction information corresponds.

10. The communication method for mobile devices according to claim 7, wherein the one-step operation on the first mobile device comprises:
a one-step operation on a screen of the first mobile device, or
a one-step operation on the first mobile device itself.

11. A communication system for mobile devices, the communication system comprises a first mobile device and a second mobile device, wherein
the first mobile device is for obtaining additional instruction information that corresponds to a first user operation during communication by sensing the first user operation; the first user operation comprises at least one of a voice-activated operation or a one-step operation on a first mobile device; and transmitting the additional instruction information to a second mobile device after the acquisition module obtains the additional instruction information that corresponds to the first user operation; and
the second mobile device is for receiving the additional instruction information transmitted by the transmitting module, and recognizing the additional instruction information to further notify a second user of the second mobile device of the first user operation.

12. The communication system for mobile devices according to claim 11, wherein transmitting, by the first mobile device, the additional instruction information to the second mobile device comprises:
inquiring pre-stored first correspondence between additional instruction information and encoding information of additional instruction information, to obtain the encoding information to which the additional instruction information corresponds; and
transmitting the encoding information of the additional instruction information to the second mobile device.

13. The communication system for mobile devices according to claim 12, wherein inquiring, by the first mobile device, the pre-stored first correspondence between additional instruction information and encoding information of additional instruction information, to obtain the encoding information to which the additional instruction information corresponds comprises:
locally inquiring pre-stored first correspondence between additional instruction information and encoding information of additional instruction information, to obtain the encoding information to which the additional instruction information corresponds, or
inquiring a first server for pre-stored first correspondence between additional instruction information and encoding information of additional instruction information, to obtain the encoding information to which the additional instruction information corresponds.

14. The communication system for mobile devices according to claim 11, wherein receiving, by the second mobile device, the additional instruction information transmitted by the transmitting module, and recognizing the additional instruction information to further notify a second user of the second mobile device of the first user operation comprises:
receiving the encoding information of the additional instruction information inquiring pre-stored second correspondence between additional instruction information and encoding information of additional instruction information, to obtain the encoding information to which the additional instruction information corresponds;
recognizing the additional instruction information to further notify a second user of the second mobile device of the first user operation.

15. The communication system for mobile devices according to claim 14, wherein inquiring, by the second mobile device, the pre-stored second correspondence between additional instruction information and encoding information of additional instruction information, to obtain the encoding information to which the additional instruction information corresponds:
locally inquiring, by the second mobile device, the pre-stored second correspondence between the additional instruction information and the encoding information of additional instruction information, to obtain the encoding information to which the additional instruction information corresponds, or
inquiring, by the second mobile device, a second server for the pre-stored second correspondence between the additional instruction information and the encoding information of additional instruction information, to obtain the encoding information to which the additional instruction information corresponds.
